(19) United States
(12) Patent Application Publication
(10) Pub. No.: US 2024/0217826 A1
(43) Pub. Date: Jul. 4, 2024

(54) METHOD FOR TRIGGERRING A SELF-PROPAGATING PROCESS OF REDUCTION-EXFOLIATION OF GRAPHENE OXIDE IN POROUS MATERIAL

(71) Applicant: MASARYKOVA UNIVERZITA, Brno (CZ)

(72) Inventors: Mirko CERNÁK, Bratislava (SK); Richard KRUMPOLES, Martin (SK); Frantisek ZELENÁK, Bratislava (SK)

(21) Appl. No.: 18/288,848

(22) PCT Filed: May 3, 2022
(86) PCT No.: PCT/CZ2022/050047

§ 371 Date: Oct. 30, 2023

(30) Foreign Application Priority Data
May 5, 2021 (CZ) PV 2021-224

(51) Int. Cl. C01B 32/192; H05H 1/24; H05H 1/46

(52) U.S. Cl. CPC C01B 32/192; H05H 1/2441; H05H 1/46; C01P 2004/03

(57) ABSTRACT

The method relates to triggering a self-propagating reduction-exfoliation process of graphene oxide in a porous material containing graphene oxide to increase the total electric conductivity and the specific surface area of the porous material. It's subject matter consists in that the initial electric plasma is generated in the adjacent part and only partly in the inside part (4) of the total volume (2) of the reduced-exfoliated porous material. This triggers the self-propagating reduction-exfoliation process, wherein to generate the initial electric plasma the parameters of the following group are fulfilled: the temperature of the working gas is less than 400° C., the pressure of the working gas is higher than 10 kPa, the speed of the working gas is less than 0,1 mxs⁻¹, the temperature of the total volume of the porous material is less than 200° C.

### FIELD OF THE INVENTION

The invention relates to a fast method applicable in industrial mass production of self-propagating process of reduction-exfoliation in porous material containing graphene oxide.

### BACKGROUND OF THE INVENTION

Graphene has attracted significant scientific and technological attention for its remarkable electronic and thermal conductivity, large specific surface area, high chemical stability, and mechanical strength. Nowadays, various methods are used to prepare graphene, where graphene oxide (GO) reduction has great potential for mass production of graphene since GO can be produced from graphite on a large scale with cost-effective chemical methods.

To better understand the invention it shall be explained that graphite is a hexagonal non-metallic mineral composed of atoms of carbon organized in a layered crystalline lattice. It is possible to produce graphene oxide (GO) from graphite. GO is a compound composed of carbon, oxygen and hydrogen in various ratios and is obtained by processing graphite by means of oxidizing agents and acids. This means that other atoms apart from carbon, especially atoms of oxygen, are introduced in the layered structure of graphite. GO is understood a thin sheet removed from the layered structure of graphite containing both, atoms of carbon and atoms of other elements.

The decomposition of the layered structure to thin sheets is called exfoliation. The process of removing atoms of oxygen from the structure is called reduction.

Graphene oxide consists of flakes composed of sp2 hybridized atoms of carbon of various sizes with different oxygen-containing groups attached to atoms of carbon. Several types of oxygen-containing functional groups present on the basal plane of a GO flake and the flake edge allow GO to interact with a broad range of organic and inorganic materials, but at the same time disrupt the conjugated aromatic graphene network and render GO flakes electrically insulating. The conductivity of GO necessary for many important applications can be dramatically increased by removing the oxygen-containing groups to form reduced multilayer graphene oxide (rGO) platelets with a related increased surface area and electric conductivity, which can be utilized as an alternative to graphene. The partial restoration of the graphitic structure can be accomplished via thermal US 2007/0092432, chemical US 201703126951, microwave Han Hu, Carbon 50 (2012) 3267-3273, laser U.S. Pat. No. 8,883,042, and hydrogen plasma reduction U.S. Pat. No. 8,182,917. The reduced graphene oxide (rGO) can be functionalized for use in different applications by, for example, treating rGO with other chemicals, by electric plasmas YIQING Wang et al.: J. Mater. Chem. A (2017) DOI: 10.1039/c7ta08607e, or by creating new compounds by combining rGO with other materials.

Also, a number of “reduction-exfoliation” techniques have been reported which involve vacuum exfoliation, chemical exfoliation, and exfoliation at high temperature, i.e., the thermal exfoliation US 2007/0092432. Regarding the most commonly used thermal “reduction-exfoliation” Mc Allister et al.: Chem Mater, 2007, 19, 4396-4404 suggested a critical temperature of 550° C. In the technical praxis, however, the employed treatment temperature for full exfoliation to single or few layered graphene sheets is normally above 1000° C. which is energy-intensive and difficult to be controlled, making this process unsuitable for mass-production of rGO. Moreover, the high-temperature heating process damages the structure of the platelets as pressure increases and H₂O and CO₂ gases are released having a potential negative effect on the mechanical strength and conductivity of the rGO thus produced.

For the sake of saving energy and better manufacturing process control, several studies have tried to lower the reduction-exfoliation temperature using porous GO materials. S. Shivakumara et al. 2015 ECS Electrochem. Lett.4 A87 observed the slow (10 min.) thermal exfoliation of a GO powder at 200° C. under air atmosphere, where the free-loaded GO powder expanded into more fine particles. A fast low-temperature exfoliation was observed by F. Kim et al.: Funct.

Mater. 2010, 20, 2867. It occurred at initial material and environment air temperatures above 60° C. due to the self-propagating progress of reduction-exfoliation with a speed of 4 cm/s at a local exfoliation temperature of 400° C. measured by an IR thermometer. The exfoliation was triggered by a local thermal shock due to a simple tapping a GO strip thin 10-20 μm with a hot soldering iron (˜400° C.). In the context of such low-temperature well-controlled thermal exfoliation it is notable that even though the reduction of GO is highly exothermic with the energy gain being a ten times increased value of the heat input, GO has been investigated also as flame retardant material Nabipour H. et al.: Materials Chemistry and Physics 256 (2020) 123656 due to its intumescent behaviour when heated and its radical scavenging effects.

The above described low-temperature thermal exfoliation techniques have already been successfully used to fabricate rGO powders Wei Wei et al.: Ind. Eng. Chem. Res. 2020, 59, 2946-2952. However, as depicted in the same paper, only very recently a thin (˜10 μm) free standing porous rGO film was prepared at 300° C. using quite complicated and slow (over some tens of minutes) thermal exfoliation process at a carefully controlled heating rate (see Wei Wei et al.: Ind. Eng. Chem. Res. 2020, 59, 2946-2952). Such stable film was subsequently folded into a˜300 μm thick rGO sponge with a honeycomb structure used to fabricate foldable supercapacitors. In U.S. Pat. No. 8,871,821 a polymer-reinforced GO aerogel is described which was thermally exfoliated to fabricate a stable rGO porous material without decomposition of the reinforcing polymer compound in argon gas in which temperature was slowly increased from room temperature to 300° C. and held at that temperature for ten hours.

As reviewed extensively by E. F. Neustroyev in Plasma Treatment of Graphene Oxide, http://dx.doi.org/10.5772/intechopen.77396 and in S. H. B. V. Kumar, R Muydinov and B. Szyszka: Plasma Assisted Reduction of Graphene Oxide Films, Nanomaterials 2021, 11, 382 in the attempt to find an alternative to the thermal processes, several research groups observed that low-temperature reduction and exfoliation of GO can occur simultaneously at GO treatment by electric plasmas. Such reduction-exfoliation process was observed in reductive hydrogen containing plasmas Eng, AYS; Sofer, Z; Simek, P; Kosina, J; Pumera, M, 2013: Highly Hydrogenated Graphene through Microwave Exfoliation of Graphite Oxide in Hydrogen Plasma: Towards Electrochemical Applications. Chemistry a European Journal 19(46), p. 15583-15592, doi: 10.1002/chem.201303164, Seung Whan Lee et al.: J. Phys. Chem. Lett. 2012, 3, 772-777, in chemically inert argon plasma M. Cardinali et al: Chemical Physics Letters 508 (2011) 285-288, in nitrogen plasma K. Wang et al.: Nano Energy 31(2017) 486-494, where it often occurs simultaneously with nitrogen doping, but quite surprisingly also in typically oxidative air plasma V. Kedambaimoole ACS Appl. Mater. Interfaces 2020, 12, 15527-15537.

Electric plasma is a reactive mixture of ions, electrons, and neutrals. It is generated by injecting sufficient energy into a working gas so that it becomes partly or fully ionized. The energy can be supplied for example, in the form of high electrical fields resulting in the so-called electron impact ionization, by heat, and by laser irradiation. The density of electrons and ions is nearly identical rendering the plasma as a whole nearly electrically neutral. In a plasma the charged particles density must be high enough and the electrically neutral gas volume sufficiently filled by electrons and ions so that each particle can influence the nearby particles and thus generate collective effects. This is why the plasma is dominated by electric and/or magnetic forces.

The most important feature of “cold” non-equilibrium electric plasmas generated by various types of electrical discharges is that they can often be far from thermodynamic equilibrium.

Therefore, desired chemical process can be conducted even under low working gas temperature conditions. In this respect, the non-equilibrium plasma is attractive for many material processings including the plasma “reduction-exfoliation” of GO containing porous materials.

This process specified for example in Quan Zhou et al.: J. Mater. Chem., 2012,22, 6061-6066, and Keliang Wang et al.: Nano Energy 31 (2017) 486-494 is generally considered to be due to effects caused by energetic plasma electrons and ions, or by local heating by the plasma generated within a limited plasma volume where the strength of the local electric field is above the so-called critical field value, sometimes termed also the dielectric strength of a gas. More specifically, it is assumed that polar chemical bonds in the oxygen-containing groups of GO can be distorted by energetic plasma electrons and ions, causing the release of a large amount of H₂O and CO₂ within nanoseconds. As a result, the gas pressure between the GO layers is increased to a level where the van der Waals force could no longer hold the layers together and, consequently, a fast expansion producing sheets of reduced graphene oxide occurs.

As reviewed by R. Trusovas et al.: Adv. Optical Mater. 2016, 4, 37-65 numerous research groups have been investigating a laser irradiation of GO because of its potential for a spatially well controlled reduction and exfoliation of GO. It was observed that an intense laser irradiation of GO results in the formation of a small plasma volume, the so-called plasma plume U.S. Pat. No. 8,883,042. According to J. Serrano et al.: Spectrochimica Acta Part B 97 (2014) 105-112 it occurs at the incident laser fluence above 7.7 J.cm⁻². Similarly, as in the case of the above discussed atmospheric pressure plasmas, the treatment of GO containing materials using such small laser-generated plasma volumes results in limited and spatially controlled reduced-exfoliated rGO volume, which is useful for the patterning, but of limited scalability necessary for a large-area rGO fabrication. M. Trenn et al.: Proc. SPIE 11105, Novel Optical Systems, Methods, and Applications XXII, 1110502 (9 Sep. 2019); doi: 10.1117/12.2529261, notes that the role of the plasma plume in the laser reduction of GO is not well understood D. A. Sokolov et al.: Carbon 53(2013)81-89 and typically is neglected R. D. Rodriquez et al.: Mater. Horiz., 2020,7, 1030. As a consequence, generally accepted laser-based approaches implicate only photoreduction, photochemical or thermal processes as the primary GO reduction pathways. R. Trusovas et al.: Adv. Optical Mater. 2016, 4, 37-65 states that GO photoreduction occurs when the photon energy exceeds 3.2 eV (387 nm); while, when the laser irradiation wavelength is lower than 390 nm (excimer lasers −248 nm), the photochemical effect dominates. However, if the laser wavelength is larger than 390 nm, the GO reduction is caused mainly by the photothermal process.

The plasma treatment of GO may be easily performed in gas discharges generated at low pressures (say less than 0.1 atm) in still or flowing plasma working gases by immersing the treated porous GO containing material into a large volume of a uniform filament-less plasma K. Wang et al.: Nano Energy 31 (2017) 486-494. Although low-pressure gas discharge plasma processes are well understood and are used extensively in the semiconductor industry, the fact that vacuum conditions are necessary, makes the low-pressure plasma treatment impractical for high throughput and low-cost manufacturing of rGO. Among other disadvantages, the low-pressure plasma treatment of graphene oxide also causes the destruction of the original shape of the material into fine particles of reduced graphene oxide.

The development of atmospheric pressure plasma sources to replace plasma processing in vacuum system is a current trend in industrial plasma engineering. However, extending the pressure range, which potentially reduces the treatment cost and allows a faster plasma reduction-exfoliation of large areas and volumes of GO containing materials has been hampered by the fact that the area exposed to the plasma, plasma uniformity, and the plasma volume decrease continuously with increasing the pressure: At pressures above some 0.1 atm the plasma typically contracts to a highly conductive hot narrow spark-like filaments.

The treatment of GO containing materials using small plasma volumes results in limited and spatially controlled reduced-exfoliated volumes with increased conductivity and internal surface area that is useful, for example, to pattern the conductive rGO onto the GO paper and GO coated textiles Zheng Bo et al.: J. Phys. Chem. C 2014, 118, 13493-13502, V. Kedambaimoole et al.: ACS Appl. Mater. Interfaces 2020, 12, 15527-15537. On the other hand, the localized plasma treatment area and volume constitute significant limitation and technical problem particularly for the highly demanded atmospheric-pressure plasma-assisted high-throughput manufacturing of large area and volumes of free-standing porous materials containing graphene oxide reduced by means of plasma generated under atmospheric pressure. These are conductive and flame retardant textiles, lightweight electromagnetic wave absorption materials, electrode materials for batteries and supercapacitors, materials for solar energy collection, catalyst supports, materials for adsorption removal of radionuclides, arsenic, antibiotics, bilirubin. etc.

To treat such large-area GO containing materials using common commercially available atmospheric pressure plasma sources, the treatment must usually be done by a plasma jet scanning of the area to be reduced at impractically long total plasma exposure times typically more than 1 min., F. Alotaibi, Carbon 127 (2018) 113e121. In a typical plasma jet the plasma working gas is flowing with a speed above 1 m/s and is simultaneously ionized in a limited space volume where the electric field is higher than the critical field strength creating there a flow of the ionized plasma working gas A. Dey et al.: Phys.Chem.Chem.Phys., 2020, 22, 7685, Ying Zhao et al.: AIP Advances 10, 015216 (2020). The ionized plasma working gas can be produced also by heating the plasma working gas to become ionised at the plasma working gas temperature above say 800° C. as assumed by Chii-Rong Yang et al.: Nanomaterials 2018. 8, 802. Subsequently the ionized plasma working gas flows through a plasma nozzle at a speed higher than 1 m/s creating just behind the nozzle an electric plasma volume with the plasma flow towards the treated material localized in a low-electric-field region at a distance larger than 1 cm from the plasma nozzle.

The long treatment time in the order of minutes is characteristic also for the atmospheric-pressure plasma reduction of porous materials containing graphene oxide immersed into volumetric filamentary plasmas of the so-called volume dielectric barrier discharges (DBDs) well known in the art Quan Zhou et al.: J. Mater. Chem., 2012,22, 6061-6066, Yiqing Wang et al.: J. Mater. Chem. A 2017 DOI: 10.1039/c7ta08607e. Because the electric field strength inside of the porous material treated by the volume DBDs is higher than a critical field strength necessary for the gas ionization by electron impact, the plasma filaments enter the porous material volume with the high field causing inside localized thermal and mechanical damages. As a consequence, this technique is not convenient for the fabrication of free standing and porous rGO based materials as aerogels, foams, sponges, membranes, and various composites, which are highly demanded in many applications like energy storage, catalysis, environmental remediation, etc. As observed by Y. Wang et al.: Journal of Materials Science: Materials in Electronics (2019) 30:8944-8954 the damage caused by the plasma filaments to such materials can be eliminated by operating DBD at a reduced pressure of 0.2 atm.

As a solution to some of the above shortcomings of the volume DBDs plasma reduction of GO due to the plasma filaments damaging the treated GO porous structure, the team with the participation of two of the Inventors, using a unique atmospheric-pressure plasma source the so-called Diffuse Coplanar Barrier Discharge (abbreviation recognized by those skilled in the art is DCSBD) capable of generating large areas of diffuse atmospheric pressure plasmas, successfully reduced a mesoporous thin inkjet-printed flexible GO layer in reductive hydrogen plasma at the treatment times of 4 s T. Homola et al.: ChemSusChem 2018, 11,941-947. This, plasma source depicted in EP 1 387 901 provides thin (0.3 mm) uniform plasma volume over much larger surface areas than previous plasma generators.

Nevertheless, as found by T. Homola et al., this method is not applicable for the plasma reduction of mesoporous materials thicker than approximately 300 nm. Even though it is applicable for the large area plasma treatment, it is not appropriate for the treatment of mesoporous materials with thickness above 300 nm and for the treatment of materials with a typical pore size above the order of 0.001 mm and thicker than 0.3 mm M. Simor et al.: Appl. Phys. Lett. 81, 2716 (2002). Moreover, the use of hydrogen plasma gas is not practicable, safe, or economic for large scale industrial applications.

It is the object of the invention to create a method for carrying out the process of reduction-exfoliation in porous material containing graphene oxide that would overcome the shortcomings of the above cited state of the art, that would be fast, applicable in industrial and mass production, sustainable from the view of financial costs and that would be safe from the view of application of non-flammable and non-toxic working gases for plasma generation.

### DISCLOSURE OF THE INVENTION

The above described object of the invention is solved by creating a method of triggering a self-propagating reduction-exfoliation process of graphene oxide in a porous material containing graphene oxide according to the present invention.

The method relates to triggering a self-propagating reduction-exfoliation process of graphene oxide in a porous material containing graphene oxide to increase electric conductivity and the specific surface area of the porous material.

The subject matter of the invention consists in that the initial electric plasma is generated in the adjacent part and only partly in the inside part of the total volume of the reduced-exfoliated porous material. This triggers the self-propagating reduction-exfoliation process, wherein to generate the initial electric plasma the parameters of the following group are fulfilled: the temperature of the working gas is less than 400° C., the pressure of the working gas is higher than 10 kPa, the speed of the working gas is less than 0.1 mxs⁻¹, the temperature of the total volume of the porous material is less than 200° C.

The disadvantages of the thermal and plasma reduction-exfoliation techniques of graphene oxide described in the background of the invention part that are applied in the whole volume of the prepared sample can be overcome using a hitherto undescribed fast, on the order of seconds, self-propagating reduction-exfoliation process taking place at gas pressures above 10 kPa and at temperatures of the material less than 200° C., wherein the strength of the Laplacian electric field in the volume of the prepared sample is lower than the critical electric field strength.

The primary benefit of the invention consists in that the initial electric plasma is generated only in a part of the total volume, whereupon the invention takes advantage of the triggered self-propagation of a hitherto unknown reduction-exfoliation process. The invention applies the local triggering of the hitherto unknown reduction-exfoliation process with an avalanche extension in the rest of the total volume for an industrial mass employment to modify porous materials containing graphene oxide.

The hitherto unknown reduction-exfoliation process can be triggered by the electric discharge plasma reduction-exfoliation already known in the art. As depicted for example, in Quan Zhou et al.: J. Mater. Chem., 2012, 6061-6066, and Keliang Wang et al.: Nano Energy 31 (2017) 486-49 the discharge plasma reduction-exfoliation known in the art is due to bombardment of GO by energetic discharge plasma electrons present within a limited discharge plasma volume where local values of the so-called Laplacian electric field are higher than the so-called critical electric field strength necessary for the electron impact ionisation generating the energetic plasma electrons and specific for the plasma gas used.

As well known in the art, see S. Celestin et al.: Eur. Phys. J. Appl. Phys. 47, 22810 (2009), local values of the Laplacian electric field are determined by the geometry of discharge electrode system used to generate the plasma and electric voltage applied to the electrodes without the discharge plasma. Except for the plasma generated by an intense irradiation of GO containing materials by lasers depicted in U.S. Pat. No. 8,883,042 and the plasma jets well known in the field, where the electrons, ions, and neutral plasma species are transported to the porous GO materials at electric field values less than the critical field strength by a fast flow of the ionized working plasma gas with the velocity above of 0.1 m/s, there is no known prior art in the specific field of this invention where the electric plasma containing the energetic electrons was generated in the immediate vicinity and inside of a GO containing porous material at the local values of the Laplacian electric field below the critical electric field strength. This is the advantage of the present invention employing a hitherto unknown reduction-exfoliation process.

In a typical electric discharge the primary ionization process generating the plasma is due to electron impact ionization of working gas molecules when the electrons can gain sufficient energy within the mean free path from the electric field to cause ionization. For example, the ionization energies for nitrogen and oxygen molecules are 15.5 and 12.2 eV, and the corresponding mean electron free paths at the atmospheric pressure are 6.28 and 6.79 μm respectively. Thus, at normal gas pressure and temperature conditions, a voltage of about 10⁴-105 V is required to cause the plasma-generating electric discharge for a 1 cm gas gap corresponding to the critical electric field about 10-100 kV/cm. The critical electric field, also termed the breakdown electric field, is specific for any plasma working gas, and in atmospheric air it is known to be 3.0×10⁴ V/cm.

The present inventors have found that the initiating plasma volume taking the form of a small (of ˜1 mm radius) plasma plume can be generated also by an excimer or CO₂ laser irradiation at the incident laser fluence above 10 J.cm⁻².

It is therefore advantageous to make use of the fact that after triggering the process by a localized initial plasma, the reduction-exfoliation process propagates spontaneously in the adjacent volume of the porous material, i.e. without any apparent external cause or stimulus, and the propagation of which occurs under a different mechanism than the plasma and thermal reduction-exfoliation processes known in the art.

It is an object of the invention to provide a method of a fast and low-temperature reduction-exfoliation of porous materials containing graphene oxide that results in an increase of electrical conductivity and porosity of these materials.

It is advantageous for carrying out the invention that at least one of the following conditions applies: the working gas contains less than 50% of noble gas; the working gas contains less than 5% of hydrogen gas.

It is advantageous, if the initial electric plasma is generated by means of dielectric barrier discharge, especially by a diffuse surface dielectric barrier discharge.

Regarding the state of the art techniques that operate with slow and technically demanding methods of chemical reduction-exfoliation or with energetically demanding and regarding a pending risk of explosion dangerous methods of thermal reduction of porous materials containing graphene oxide which degrade the useful properties of the graphene oxide and the required operation parameters of which render them inapplicable in mass industrial employment, they are fully overcome by the invention that triggers by a local action of the initial plasma discharge a hitherto unknown self-propagating reduction and exfoliation process.

Technical parameters for generation the initial electric plasma discharge are so undemanding that the present invention can be introduced in mass industrial production whilst reasonable operation costs are maintained as well as high safety standards. The process self-propagates on the order of seconds, which also overcomes the known methods of carrying out the reduction and exfoliation process.

### BRIEF DESCRIPTION OF THE DRAWINGS

The present invention will be described in more detail in the drawings where:

FIG. 1A is a photograph of an initial electric plasma volume generated in the area of approximately 4.5 cm by 1.5 cm and the thickness of 0.3 mm generated by a coplanar surface dielectric barrier discharge in laboratory air in the volume where Laplacian electric field values are above the critical field strength above approximately 3.0×10⁴ V/cm.

FIGS. 1B and 1C are a photograph and a schematic picture, respectively, of the initial electric plasma volume of FIG. 1 in contact with a part of the graphene oxide sample just before the start of the plasma reduction-exfoliation at the time t=0. The initial plasma volume is not well discernible in FIG. 1B because of an intense external light necessary for taking the photograph.

FIG. 1D is a photograph taken at t=50 ms and it illustrates the plasma reduction-exfoliation process occurring in the volume of the porous material where the Laplacian electric field values are above the critical field strength.

FIGS. 1E to 1G are photographs taken in different time and they show the reduction-exfoliation process occurring in the volume of the porous material where the Laplacian electric field values are below the critical field strength.

FIG. 2 shows temporal development of the sample temperature in time during the plasma triggered reduction-exfoliation process illustrated by FIGS. 1B-1D.

FIG. 3A is an image of an original aerogel sample of graphene oxide from a scanning electron microscope.

FIG. 3B is an image from the scanning electron microscope of the original sample of graphene oxide after the reduction-exfoliation process triggered according to the invention that generated the reduced graphene oxide shown.

FIG. 4 are photographs of a 3D self-standing structure of the samples of reduced graphene oxide prepared by plasma triggered reduction-exfoliation process illustrated by FIGS. 1B-1D.

FIG. 5A is a so-called aerogel “cake” of graphene oxide situated on the surface of a commercial DCSCD electrode system.

FIG. 5B is a so-called aerogel “cake” of reduced graphene oxide fabricated according the present invention by the plasma triggered reduction-exfoliation of the GO aerogel cake in nitrogen gas atmosphere at atmospheric pressure.

FIG. 6 is sample of PP (polypropylene) nonwoven fabric coated by a thin, porous graphene oxide layer partly reduced-exfoliated according the present invention.

FIG. 7 is a sample or reduced graphene oxide fabricated according the present invention using the volume DBD plasma triggered reduction-exfoliation of graphene oxide.

FIGS. 8 and 9 are schematic illustrations of the interception of the plan view of the graphene oxide sample and the initial volume of plasma.

FIGS. 10A and 10B are schematic illustrations of the sample placed in a device from the side view.

### EXAMPLES OF THE PREFERRED EMBODIMENTS OF THE INVENTION

It shall be understood that the specific embodiments of the invention described and illustrated hereinafter are presented for purposes of illustration and not as a limitation of the invention to the examples provided. Those skilled in the art will find or be able to provide, using routine experimentation, a greater or lesser number of equivalents to the specific embodiments of the invention described herein.

Using the term “graphene oxide (GO) containing” it is meant that GO is present in the porous material treated according to the invention, which does not exclude the presence of other compounds, materials, and particles. Typically, the porous material to be treated according to the invention can have the structure of a powder layer, an open cell foam, GO paper or aerogel which can be reinforced with polymers, sponge and other free-standing structures, a non-woven fiber structure, or a woven fiber structure.

The term “porous” refers to a GO containing material which is permeable such that fluids are movable therethrough by way of pores or other passages.

There is no particular lower limit to the content of GO in the treated material. For example, the relative GO content can be very low if the material to be treated is a fiber structure consisting of relatively thick polymer fibers coated by a thin layer of GO.

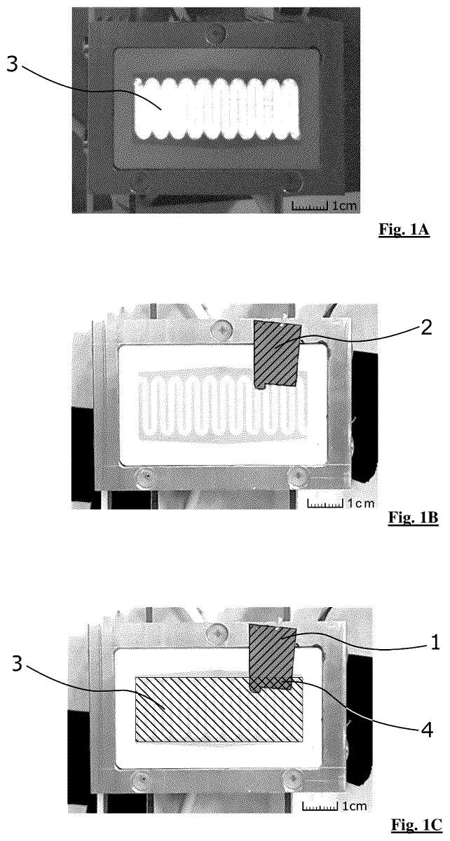

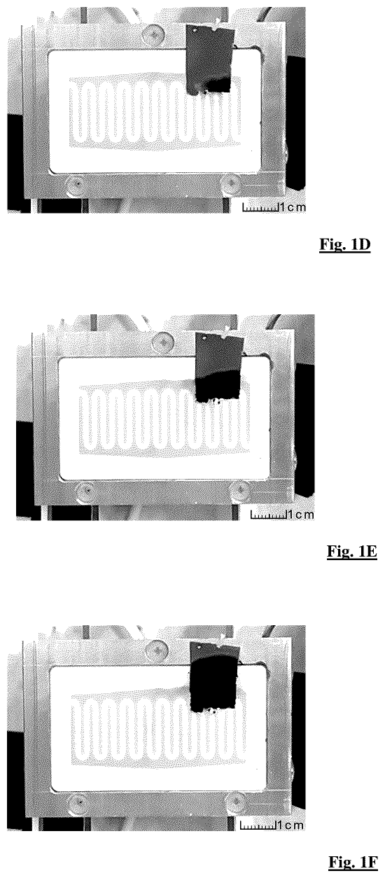

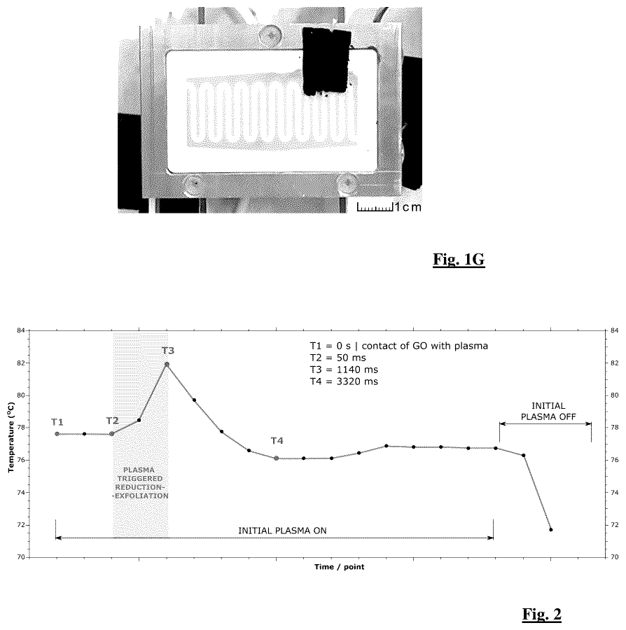

FIG. 1A taken at a low external light irradiation shows well discernible bright initial plasma volume 3 generated in the laboratory air volume above the DCSBD electrode system, such as depicted in (M. Simor et al.: Appl. Phys. Lett. 81, 2716 (2002) at voltage of 7.9 kV that is 50% above the discharge onset voltage). The initial plasma volume 3 of a 0.3 mm thickness and 1.5 cm by 4.5 cm area was generated in the laboratory air volume, where the values of the Laplacian electric field were higher than the value of the critical electric field.

FIG. 1B shows a sample of self-standing GO aerogel of the thickness approximately 1 mm with its total volume 2 situated partly on the surface of DCSBD electrode system at the moment of the onset of the initial plasma volume 3. However, the initial plasma volume 2 is not discernible in FIG. 1B because of an intense external light necessary for taking the photograph.

The volumes 1, 2 and 4 are schematically illustrated in FIG. 1C. Note that this is one example of many possible experimental arrangements and techniques generating the initial electric plasma volume 3 also inside a part 4 of the total volume 2 of the porous GO containing material to be reduced-exfoliated. As illustrated by FIG. 1C a part of the thin initial plasma volume 3 was intersecting with the part 4 of the volume of the sample, i.e., was in contact and penetrating vertically less than 0.3 mm into the volume 2. In this small part 4 where the local electric field values were higher than the critical value of 3.0×10⁴ V/cm, the plasma reduction-exfoliation process known in the art took place.

The plasma reduction-exfoliation process occurring in a limited part 4 of the volume due to the formation of initial volume 3 of the initial electric plasma at the vertical distance from the electrode system surface less than 0.3 mm quickly triggered the vertically propagating hitherto unknown reduction-exfoliation process within the full sample thickness. Both these processes resulted in the formation of a black area of the reduced GO well apparent in FIG. 1D taken 50 ms after the initial plasma discharge onset. FIGS. 1E-1G illustrate the hitherto unknown fast reduction-exfoliation process spontaneously propagating horizontally outside of the initial volume 3 of the initial electric plasma with a speed of approximately 10 cm/s.

FIG. 1G shows the situation after the completed reduction-exfoliation of the full volume 2 of the sample. From the change of the sample colour from dark brown (GO) to black (reduced GO) it can be seen that the major part 1 of the total sample volume 2 was reduced-exfoliated not by the initial volume 3 of the initial electric plasma, but by a hitherto unknown process triggered by the initial reduction-exfoliation process in the part 4. It should be noted that this process took place also at the longitudinal distance of several millimeters from the boundary of the initiating volume 3 of the initial electric plasma, where the values of the Laplacian electric field strength determined from the electrode geometry and the applied voltage geometry, were far less than the critical electric field (i.e. the dielectric strength) necessary for the initial plasma formation due to the electron impact ionization.

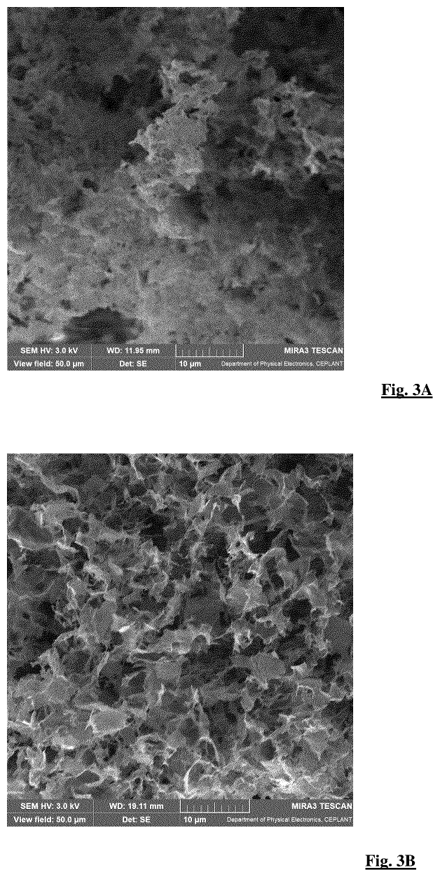

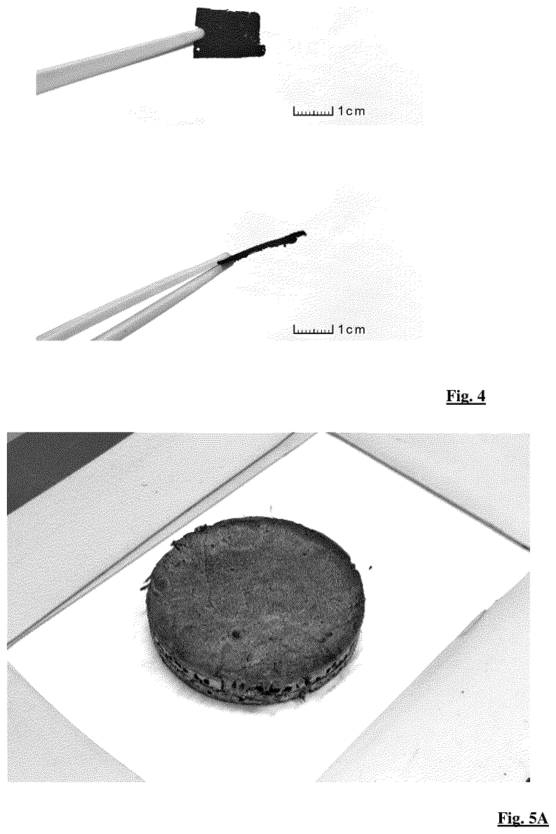

FIG. 2 shows temporal development of the temperature of the sample measured using a contact thermocouple with the marked time of the plasma onset, as well as the times of the onset and completion of the reduction-exfoliation process determined by a video camera record. It is evident that during the hitherto unknown process reduction-exfoliation the sample temperature was less than 200° C. and that the process was completed within several seconds after its triggering by a plasma reduction-exfoliation in part 4 of the volume, wherein the electrical conductivity and porosity of the sample were increased by 10 and 3 folds, respectively. The change of the porosity and micromorphology of the sample due to the reduction-exfoliation process according to the present invention is shown in FIGS. 3A-3B.

As apparent from FIG. 4, very surprisingly and in contrast to the known and often undesired mechanical effects of the plasma and reduction-exfoliation processes, the 3D self-standing structure of the very fragile GO aerogel sample was not destroyed by the reduction-exfoliation process according to the invention. This is another significant advantage of the method according to the invention apparently due to the low temperature of the process apparent from FIG. 2.

Yet another unexpected aspect of the present invention is that the results of the method according to the invention are surprisingly independent on chemical composition of the plasma working gas and, above 10 kPa also on the working gas pressure. A dopant gas may be added to the plasma working gas to provide for doping of the produced reduced GO containing porous material.

On the other hand, it should be noted that the results according to the invention are very sensitive to the chemical composition of the treated GO containing porous material as, for example, to the GO content, content of trapped interlaminar water, the content of ammonium hydroxide often used to adjust the pH value of the GO water dispersion, and to sulfone groups bonded to GO when it was prepared using the modified Hummel method.

Although there may be various electric gas discharge types used to generate the initial volume 3 of the initial electric plasma, an exemplary and non-limiting way is to use the so-called dielectric barrier discharges with different electrode geometries well known in the art to generate nonequilibrium plasmas at near-atmospheric gas pressures.

The phrase “generating the initial volume 3 of the initial electric plasma partly inside the total volume 2” as used herein refers also to the sequence when the initial volume 3 of the initial electric plasma is created outside the total volume 2 and subsequently contacted with the part 4 of the total volume 2 by, for example, a relative movement of the initial volume 3 of the initial electric plasma to the total volume 2 of the treated GO material.

The term “plasma gas temperature”, as used herein, refers to the rotational temperature of the electrically neutral gas molecules in the plasma that has been used widely as gas temperature measurement in different types of electric plasmas and has been assumed to be in equilibrium with translational temperature of the gas molecules.

The term “initial electric plasma”, refers to a classical electric plasma where the following applies: proportions of the generated plasma are substantially larger than the so-called Debye length well known from the present electric plasma theory. As inferred from, for example (Davide Mariotti and R Mohan Sankaran 2010 J. Phys. D: Appl. Phys. 43 323001), under the conditions of the present invention the Debye length is approximately on the order of 10-4-10-5 m.

### Example 1

The method according to the present invention was used to reduce-exfoliate the graphene oxide sample identical to that shown in FIGS. 1B-1C. The reduction-exfoliation process was triggered by an initial electric plasma generated by irradiating the sample by an intensive plume.

The sample was prepared as follows: Water dispersion of graphene oxide flakes of size <20 μm and concentration of 2.5%=25 mg/mL (Advanced Graphene products, Poland) was diluted 1:10 in water. After the ultrasonic homogenization (60 min) the water dispersion was coated on a polyimide substrate by air-brush method at sub-atmospheric pressure and room temperature. Subsequently, the thick GO sheet, similar to thick paper, was dried at room temperature in the vacuum (100 Pa) for 12 hours to prepare a highly porous GO sheet sample.

The sample was at a room temperature of 22° C. placed on the DCSBD electrode system similarly as shown in FIG. 1B, but the voltage applied to the electrodes was of 3.1 kV, i.e. only 50% of the discharge onset voltage necessary to ignite the DCSBD and to generate the discharge plasma and, therefore no thin discharge plasma layer such as seen in FIG. 1A was generated. Subsequently, the part of the sample localized directly at DCSBD electrode system, see FIG. 1B, was irradiated by Q-Switched Nd:YAG laser (20 Hz, 1064 nm, 8 ns pulse width) at the incident laser fluence 15 J.cm⁻² resulting in the formation of an initial volume 3 of the initial electric plasma there. Laser pulses were directed perpendicularly to the sample surface and focused to a spot of approximately 0.5 mm diameter.

The area of the laser induced initial electric plasma triggered the reduction-exfoliation process very similar to those shown in FIGS. 1D-1G.

An hour after the completion of the process the plasma reduced-exfoliated GO material exhibited the sheet resistance R_{□}=136.1±0.6 Ω._{□}⁻¹. In comparison, the measured sheet resistance of GO sheet before the plasma modification was >10⁷ Ω._{□}⁻¹. The sheet resistance was measured and analysed by four-point probe method utilizing the OSSILA resistance measuring system (T2001A3-EU). The surface areas of the original GO sample and the rGO sample prepared according to the present invention determined from the N₂ adsorption/desorption isotherms were 150 m²/g and 650 m²/g (after modification), respectively.

### Example 2

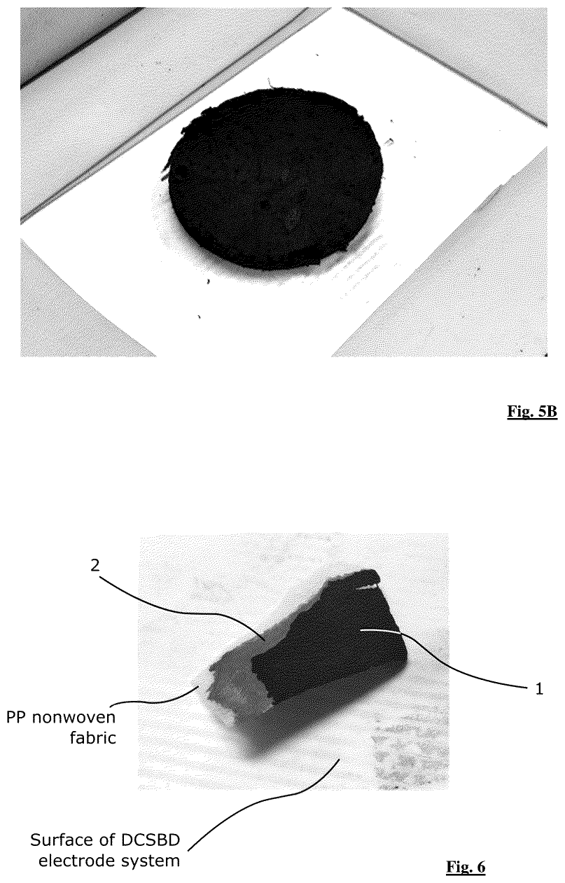

A GO aerogel cake of 5.5 cm diameter, 1.5 cm thickness of dark brown colour shown in FIG. 5A was fabricated under mild conditions from an aqueous solution of GO by drying in a vacuum oven at 60° C. for 24 hours. The GO cake was placed at a room temperature on the electrode system surface of a commercial initial DCSBD plasma source supplied by Roplass Ltd. (Bmo, Czech Republic) in nitrogen gas atmosphere at atmospheric pressure. The initial plasma source energized by 8.6 kV alternating voltage generating electrical discharge of 90 W total plasma power. The fast plasma triggered reduction-exfoliation process according to the present invention was triggered by the initial DCSBD plasma in 2 s after the nitrogen plasma ignition and completed in next 2 s, as indicated by the black colour of the reduced-exfoliated GO material shown in FIG. 5B. As determined by an X-ray photoelectron spectroscopy XPS analysis of the material the nitrogen-doped reduced GO fabricated by this method has a high carbon/oxygen ratio of 10 and a nitrogen content of 3 atom %. The conductivity of N-doped aerogel measured by Four-Point Probe Meter at ambient temperature with a value of 2.4×10⁻² S m⁻¹. The porous reduced-exfoliated GO fabricated via the method according to the present invention was pressed into the thin sheet of thickness 50 μm and subsequently analysed by Four-Point Probe Meter at ambient temperature with the conductivity value of 500 S.m⁻¹.

### Example 3

A 2.50 cm×4.5 cm sample of 15 gsm polypropylene spunbond nonwoven fabric was hydrophilized by a 0.5 s exposure to laboratory air DCSBD plasma. Water dispersion of graphene oxide flakes of size <20 μm and concentration of 2.5%=25 mg/mL was diluted in the ratio 1:10 in water. After the ultrasonic homogenization (60 min) it was spread by air brush on a part of the textile sample and dried at room temperature. In this way a volume 2 of (polypropylene) PP fabric coated by a thin porous GO layer was prepared. Subsequently the sample was placed on the same DCSBD electrode system as that described in Example 2. The initial plasma source was energized by 10.5 kV alternating voltage generating a thin 21 cm by 8.5 cm by 0.03 cm laboratory air plasma volume of 400 W total plasma power in laboratory of relative humidity 30%. As shown in FIG. 6 this thin initial plasma layer triggered the process of reduction-exfoliation according to the present invention resulting in the formation of the black conductive volume of PP fabric coated by the reduced GO outside of the 0.3 mm thick initial DCSBD plasma volume. This means the initial electric plasma extended only in 0.3 mm of the total thickness of 1 mm.

### Example 4

The method according to the present invention was used to reduce-exfoliate the graphene oxide sample identical to that shown in FIG. 1A and described in Example 1. The reduction-exfoliation process was triggered by an initial laboratory air plasma generated by a volume dielectric barrier discharge (DBD).

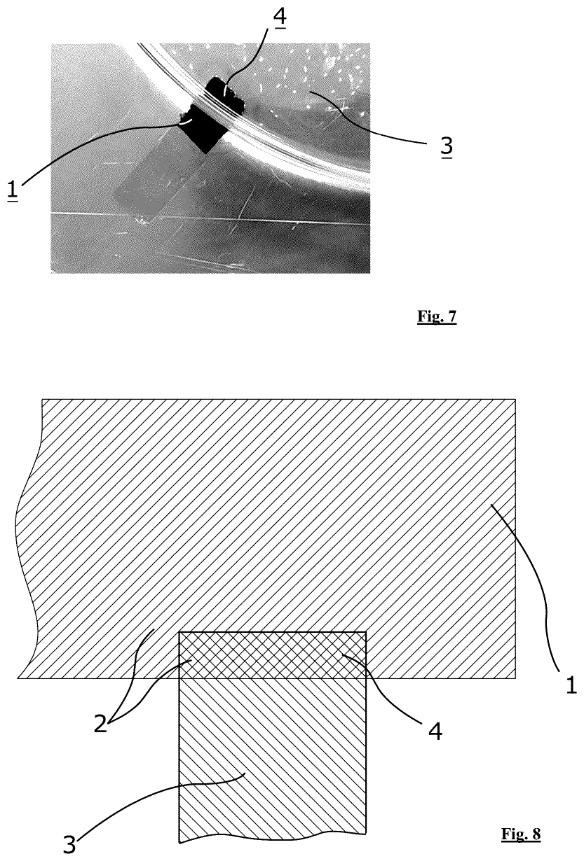

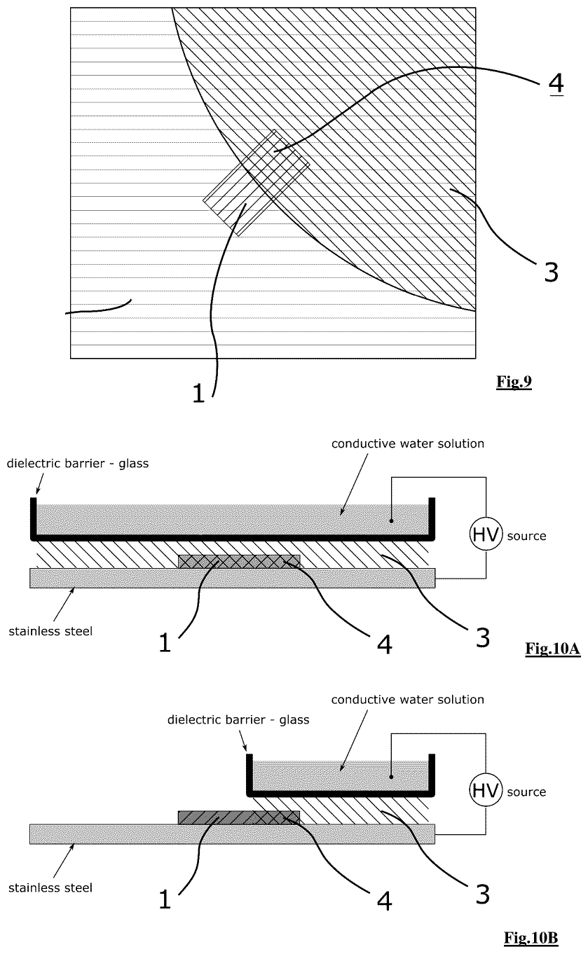

As shown in FIG. 7 the lower electrode of the volume DBD was made from an aluminium plate. The upper optically transparent electrode was made from a glass Petri dish of a diameter of 8 cm filled with electrically conductive salty water. The discharge gap between the aluminium electrode and the Petri dish bottom was 1 mm.

As illustrated by FIG. 7 the volume of GO sample identical to that described in Example 1 was inserted partly in the gap between the electrodes and fixed in such position by a tape.

Subsequently the initial volume 3 of the initial electric plasma marked by bright spots of thin plasma filaments seen in FIG. 7 was generated between the electrodes by application of 12 kV/10 kHz AC voltage. The plasma reduction-exfoliation process occurring in part 4 of the total sample volume 2 intersected by the initial volume 3 of the initial electric plasma, where the values of the Laplacian electric field are higher than the critical field of 30 kV/cm, triggered the reduction-exfoliation process according to the present invention also in the unintersected volume 1 of the sample, where the Laplacian values of electric field were much less than the critical value. Such reduction-exfoliation process resulted in the blackening of the sample evident from FIG. 6 and the sheet resistance of the reduced-exfoliated GO sample decreased to R_{□}=150±1 Ω._{□}⁻¹ which is much less than the resistance of the GO sample >10⁷ Ω._{□}⁻¹ before the reduction-exfoliation process according to the present invention.

### INDUSTRIAL APPLICABILITY

The method of self-propagating reduction-exfoliation of graphene oxide in a porous material containing graphene oxide to increase electrical conductivity and the specific surface area of the porous material created according to the invention is applicable e.g. in the development and production of electronical components, in chemical industry, in textile industry etc.

1. Method of triggering a self-propagating reduction-exfoliation process of graphene oxide in a porous material containing graphene oxide to increase the total electric conductivity and the specific surface area of the porous material characterized in that the initial electric plasma is generated in the adjacent part and only partly in the inside part (4) of the total volume (2) of the reduced-exfoliated porous material, wherein to generate the initial electric plasma the parameters of the following group are fulfilled: the temperature of a working gas is less than 400° C., the pressure of the working gas is higher than 10 kPa, the speed of the working gas is less than 0.1 mxs⁻¹, the temperature of the total volume of the porous material is less than 200° C., and at the same time the Laplacian electric field in the volume (1) of the porous material not intersected by the initial plasma (3) is less than the critical electric field of the working gas, and the working gas contains less than 5% of hydrogen gas.

2. (canceled)

3. The method according to claim 1 characterized in that the initial plasma is generated by an electric discharge in the working gas by means of the local presence of the Laplacian electric field the electric field strength of which is higher than the critical electric field strength of the working gas.

4. The method according to claim 1 characterized in that the working gas contains less than 50% of noble gas.

5. (canceled)

6. The method according to claim 1 characterized in that the initial electric plasma is generated by means of dielectric barrier discharge.

7. The method according to claim 1 characterized in that the initial electric plasma is generated using a diffuse surface dielectric barrier discharge.

8. The method according to claim 1 characterized in that the initial electric plasma is generated by laser irradiation at the incident laser fluence above 10 J.cm⁻².

9. The method according to claim 1 characterized in that the plasma working gas contains at least one gas admixture for doping of porous material containing graphene oxide during the reduction and exfoliation process.
